(19) United States
(12) Patent Application Publication
(10) Pub. No.: US 2013/0215828 A1
(43) Pub. Date: Aug. 22, 2013

(54) DYNAMIC WIRELESS DATA RATE SELECTION

(71) Applicant: T-MOBILE USA, INC., (US)

(72) Inventors: Samir HODROJ, Bothell, WA (US); Omar HASSAN, Kirkland, WA (US); Gunjan NIMBAVIKAR, Bellevue, WA (US)

(73) Assignee: T-MOBILE USA, INC., Bellevue, WA (US)

(21) Appl. No.: 13/774,984

(22) Filed: Feb. 22, 2013

Related U.S. Application Data
(60) Provisional application No. 61/601,922, filed on Feb. 22, 2012.

(51) Int. Cl. H04W 28/02

(52) U.S. Cl. CPC H04W 28/02
USPC 370/328

(57) ABSTRACT

Systems, devices and methods described herein provide or possess functionality that enables dynamically selecting a data rate from a plurality of available data rates. In one implementation, an initial data rate for transmitting a packet is reduced aggressively until it is determined that consecutive packets were transmitted successfully. In another implementation, an initial data rate is increased moderately after it is determined that consecutive packets were transmitted successfully.

### RELATED APPLICATIONS

This application is a Non-Provisional application of Provisional Application No. 61/601,922, filed Feb. 22, 2012. The entire content of the Provisional Application is incorporated herein by reference.

### BACKGROUND

Mobile phones, laptops, personal digital assistants (PDAs), base stations and other systems and devices can wirelessly transmit and receive data. Such systems and devices have used orthogonal frequency division multiplexing (OFDM) transmission schemes, such as those defined in the Institute of Electrical and Electronics Engineers (IEEE) 802 wireless communications standards. The IEEE 802 standards include IEEE 802.11, 802.11a, 802.11b, 802.11g, 802.11n, 802.11ac, 802.16, and 802.20.

In one example, a network operating according to the 802.11g standard may operate according to 12 different data rates (ranging from 1 Mbit/s to 54 Mbit/s) and using three different modulation techniques (including orthogonal frequency division multiplexing (OFDM), complementary code keying (CCK) and differential binary or quadrature phase shift keying (DBPSK/DQPSK) together with direct-sequence spread-spectrum (DSSS)). Typically, a specific modulation technique is used when transmitting at one of a group of data rates. So, for example, OFDM may be used for data rates of 6, 9, 12, 18, 24, 36, 48 and 54 Mbit/s, CCK for data rates of 5.5 and 11 Mbit/s and DBPSK/DQPSK+DSSS for data rates of 1 and 2 Mbit/s.

Various rate adaptation schemes have been proposed and used with the 802.11 standard. For example, various rate adaptation schemes use the success and failure history of previous transmissions to aid in the selection of future data or communication rates. Other rate adaptation schemes utilize signal measurements to aid selection of an appropriate data rate.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 illustrates components of a mobile device, according to an exemplary implementation.

FIG. 2 illustrates the packet transmission and acknowledgement mechanism of a wireless system, where an IEEE 802.11 wireless system may be an example thereof.

FIG. 3 is a flow diagram illustrating an example process for dynamic assignment of a data rate according to an implementation.

FIG. 4 is a flow diagram illustrating an example process for dynamic assignment of a data rate according to another implementation.

### DETAILED DESCRIPTION

Systems, devices and methods described herein provide or possess functionality that enables dynamically switching of data rates. In one implementation, a mobile device transmits a packet, at a first data rate, but does not receive an acknowledgment from a receiving device indicating that the packet was received, where the receiving device may be an access point. The mobile device attempts to retransmit the packet. Again, the mobile device does not receive an acknowledgment that the retransmitted packet was received. The mobile device attempts a second retransmission of the packet, but again does not receive acknowledgment from the receiving device. The mobile device then changes to a second data rate, which is less than the first data rate. In particular, the second data rate skips at least one data rate that intervenes between the first data rate and the second data rate. For example, if the available data rates include 1, 2, 5.5, 6, 9, 11, 12, 18, 24, 36, 48 and 54 Mbit/s, and the first data rate was set to 54 Mbit/s, the second data rate is set to 36 Mbit/s or less. In this implementation, it may be desirable to move to the lowest data rate available within no more than seven retries.

In another implementation, a mobile device transmits a first packet, at a first data rate that is less than a maximum data rate available in a plurality of data rates. An acknowledgment is received that indicates that the first packet was successfully received by the receiving device. The mobile device transmits a second packet at the first data rate. An acknowledgment is received that indicates that the second packet was successfully received by the receiving device. The mobile device then transmits a third packet at a second data rate that is greater than the first data rate.

In yet another implementation, a mobile device transmits a first packet at a first data rate, but does not receive an acknowledgment from a receiving device that the first packet was received. The mobile device then attempts to retransmit the first packet at a second data rate, which is less than the first data rate. In particular, the second data rate skips at least one data rate that intervenes between the first data rate and the second data rate. Again, the mobile device does not receive an acknowledgment from the receiving device that the first packet was received. The mobile device then attempts to retransmit the first packet at a third data rate, which is less than the second data rate. In particular, the third data rate skips at least one data rate that intervenes between the second data rate and the third data rate.

Mobile device or user device, as used herein and throughout this disclosure, refers to any electronic device capable of wirelessly sending and receiving data. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

Mobile devices may communicate with each other and with other elements via a network, for instance, a wireless network, or a wireline network. A network may include broadband wide-area networks such as cellular networks, local-area networks (LAN), Wi-Fi, and personal area networks, such as near-field communication (NFC) networks including BLUETOOTH®. Communication across a network may be packet-based; however, radio and frequency/amplitude modulation networks may enable communication between communication devices using appropriate analog-digital-analog converters and other elements. Communication may be enabled by hardware or mixed hardware and software elements called transceivers. Mobile devices may have more than one transceiver, capable of communicating over different networks. For example, a cellular telephone may include a cellular transceiver for communicating with a cellular base station, a Wi-Fi transceiver for communicating with a Wi-Fi network, and a BLUETOOTH® transceiver for communicating with a BLUETOOTH® device. A Wi-Fi network is accessible via access points such as wireless routers, etc., that communicate with the Wi-Fi transceiver to send and receive data. The Wi-Fi network may further be connected to the internet or other packet-based networks. The bandwidth of a network connection or an access point is a measure of the rate of data transfer, and can be expressed as a quantity of data transferred per unit of time.

A network typically includes a plurality of elements that host logic or intelligence for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server may include several network elements, including other servers, and can be logically situation anywhere on a service provider's network, such as the back-end of a cellular network. A server hosts or is in communication with a database hosting an account for a user of a mobile device. The user account includes several attributes for a particular user, including a unique identifier of the mobile device(s) owned by the user, relationships with other users, application usage, location, personal settings, business rules, bank accounts, and other information. A server may communicate with other servers on different networks to update a user account.

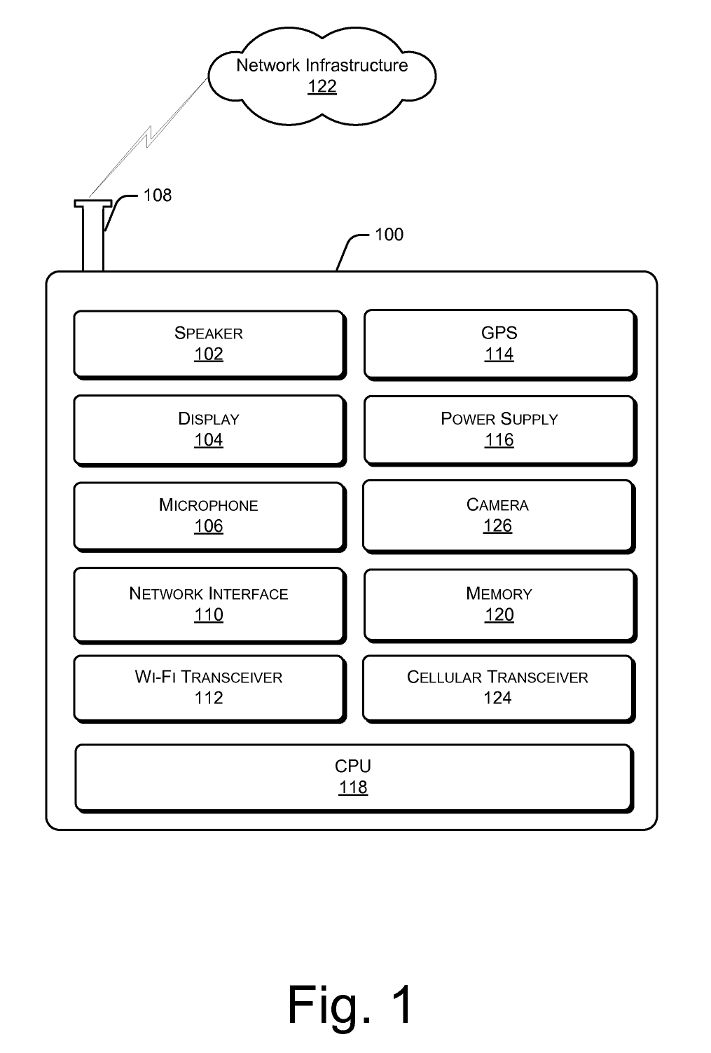

FIG. 1 illustrates components of a mobile device 100, according to an exemplary embodiment. The mobile device 100 may include a speaker 102, a display 104, a microphone 106, and an antenna 108. The mobile device 100 may further include a network interface 110, a Wi-Fi transceiver 112, a Global Positioning System (GPS) receiver 114, a power supply 116, a central processing unit (CPU) 118, and a memory 120. Furthermore, the mobile device 100 may include a cellular transceiver 124 and a camera 126. The camera 126, or what may be referred to as a general image capturing device, may capture images, obtain images from video captured by the camera 126, and capture video.

The speaker 102 provides an audio output for the mobile device 100. The display 104 may be an LCD or LED or other type of display on which a user can view selections, images, video, numbers, letters, etc. The display 104 may also be a touchscreen, thereby being used as an input device. In embodiments not using a touchscreen, a keypad is typically used as an input device, for instance, to type a phone number or a message. Such a keypad may be a numerical keypad, a QWERTY keyboard, etc. The microphone 106 allows the user to verbally communicate with others using mobile device 100. The antenna 108 is a transducer designed to transmit or receive electromagnetic waves to and from a network 122. In conjunction with the antenna 108, the network interface 110 allows the mobile device 100 to wirelessly communicate with network 122, such as a cellular network and/or an access point, or with other wireless devices across the network 122. The network 122 may include, but is not limited as such, operator equipment necessary to enable mobile devices to communicate using cellular communication technology and protocols. Furthermore, the network 122 may include servers, servers that include databases, one or more processors that execute instructions stored in memory and/or storage, and the like. Furthermore, the network 122 may include mobile devices similar to the mobile device 100. Therefore, the mobile device 100 may be in direct or indirect communication with one or more such mobile devices included in the network 122.

The network interface 110 may be a cellular transceiver, wireless transceiver, etc., and may include combinations of transceivers to communicate with assorted wireless networks. Alternatively, the network interface 110 may couple one or more transceivers of the mobile device 100 to one or more communication networks. The Wi-Fi transceiver 112 enables mobile device 100 to wirelessly communicate over short ranges with a Wi-Fi access point, and through the access point, to a packet-based network such as the Internet, and other devices on the internet. The GPS transceiver 114 enables a determination of a location of mobile device 100, by receiving signals from a GPS satellite. In addition to these signals, network interface 110 can receive assistance data from an A-GPS server on the cellular network, thereby enabling GPS receiver 114 to get a faster fix on a satellite signal. The power supply 116 provides power to each of the components of mobile device 100, and can include a battery, as well as an interface to an external power supply. The CPU 118 controls components of mobile device 100 according to instructions stored in the memory 120.

The memory 120 may be any computer readable medium, such as RAM, ROM, etc. The memory 120 may store intelligence, such as computer readable instructions, in addition to logic for operating the components of mobile device 100. The memory 120 further may store a database or have logically known assessable memory locations including media, such as images, video, files, and the like. The media stored in the memory 120 may have been captured by the camera 126.

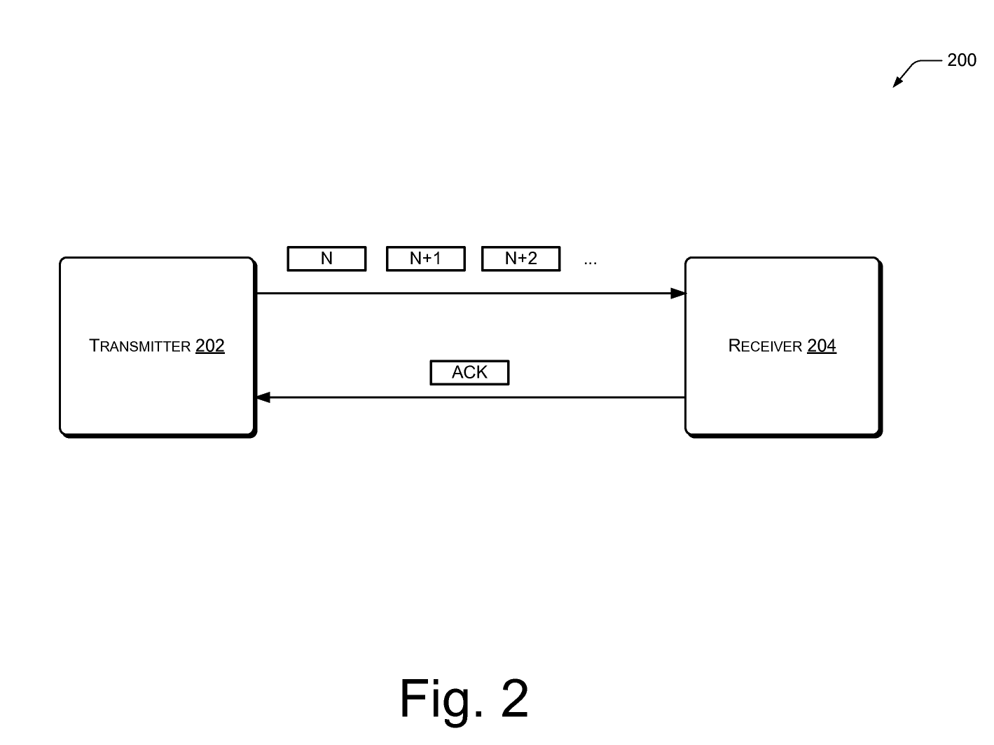

FIG. 2 illustrates the packet transmission and acknowledgement mechanism of a wireless system 200, where an IEEE 802.11 wireless system can be an example thereof. In FIG. 2, according to the standard of IEEE 802.11, after the transmitter 202 transmits a data packet to the receiver 204, the receiver 204 will demodulate the received data packet and perform a cyclic redundancy check (CRC). If the data packet is received correctly, the receiver 204 will reply an acknowledgement (ACK) packet to the transmitter 202. If the ACK packet is not received by the transmitter 202 within a predetermined period of time, the transmitter 202 will assume that the data packet was not received correctly by the receiver 204 and then retransmit the previous packet to the receiver 204. As illustrated, the transmitter 202 may transmit a plurality of packets to the receiver 204. The plurality packets are represented as N, N+1, N+2 and so on, where each of the packets N, N+1, N+2 is a separate and unique packet. If the transmitter 202 does not receive an ACK packet after transmitting packet N, the transmitter 202 may retransmit the packet N a plurality of times.

The wireless system 200 may implement a plurality of available data rates including 1, 2, 5.5, 6, 9, 11, 12, 18, 24, 36, 48 and 54 Mbit/s. However, the wireless system 200 may use more or less than indicated data rates in the foregoing. For example, the plurality of available data rates may include one or more data rates that are greater than 54 Mbis/s. Furthermore, the lowest data rate in the plurality of available data rates may be higher or lower than the 1 Mbit/s.

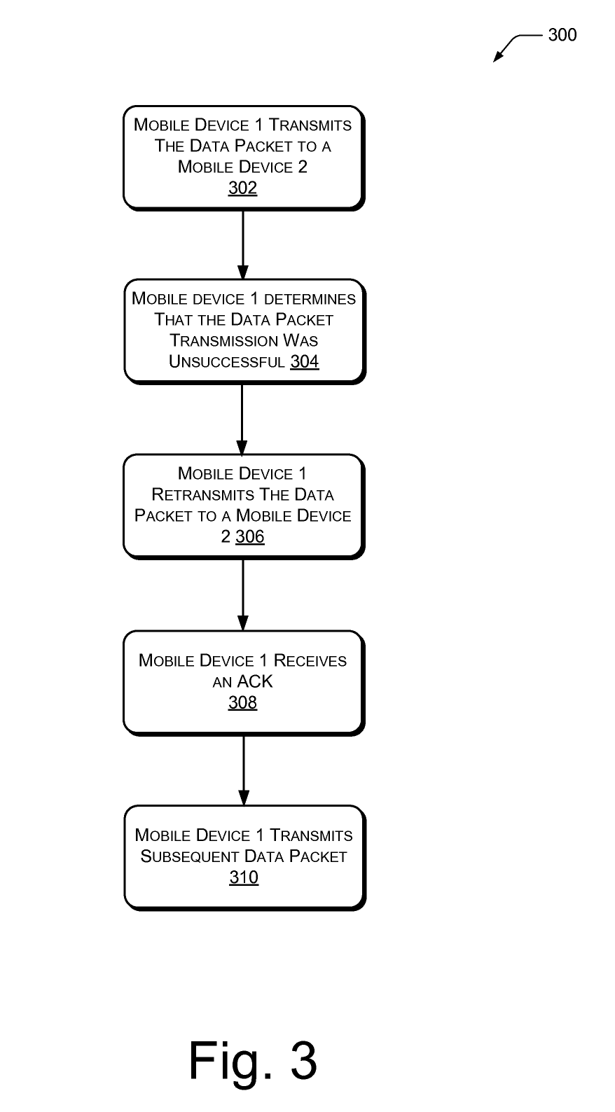

FIG. 3 is a flow diagram illustrating an example process 300 for dynamic assignment of a data rate according to an implementation. The process 300 may reference elements illustrated in FIGS. 1-2. However, generally, the disclosed process 300 may be implemented by a device, a system of devices, computer-readable medium including computer-executable instructions that, when executed, perform the process 300, and the like. The process 300 may be executed by a mobile device.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At act 302, a mobile device 1 (e.g., the mobile device 100) transmits a data packet to a mobile device 2 (e.g., a mobile device associated with the network infrastructure 122). The data packet was transmitted at a data rate chosen from a plurality of predetermined data rates. The plurality of predetermined data rates may include data rates 1, 2, 5.5, 6, 9, 11, 12, 18, 24, 36, 48 and 54 Mbit/s, where the data rates may be associated with one or more IEEE 802.11 standards. Again, the plurality of available data rates may include one or more data rates that are greater than 54 Mbis/s. Furthermore, the lowest data rate in the plurality of available data rates may be higher or lower than the 1 Mbit/s. The mobile device 1 does not receive an ACK from the mobile device 2 indicating that the data packet was received. That is, at act 304, the mobile device 1 determines that the data packet transmission was unsuccessful.

At act 306, the mobile device 1 retransmits the data packet to the mobile device 2. The mobile device 1 retransmits the data packet to the mobile device 2 at a data rate that is at least two data rates lower than the data rate used in act 302. For example, if the mobile device 1, in act 302, used the data rate 54 Mbit/s to transmit the data packet, then the data rate used in act 306 would be 36 Mbit/s to retransmit the data packet.

At act 308, the mobile device 1 receives an ACK from the mobile device 2 indicating that the retransmitted data packet of act 306 was received. At act 310, the mobile device 1 transmits a subsequent data packet at the a data rate that is greater than the data rate used in act 306. For example, in act 308, the mobile device 1 transmits the subsequent data packet at a data rate of 48 Mbit/s.

In one particular implementation of the process 300, the mobile device 1 attempts a maximum of seven data packet retransmissions before dropping the failed data packet. In one example, assuming that the data packet is retransmitted seven times and the first data rate used was 54 Mbit/s, the seventh and final data packet transmission retry will be at 1 Mbit/s. In another particular implementation of the process 300, the mobile device 1 does not execute act 306 until after at least two retransmissions of the data packet have been attempted by the mobile device 1.

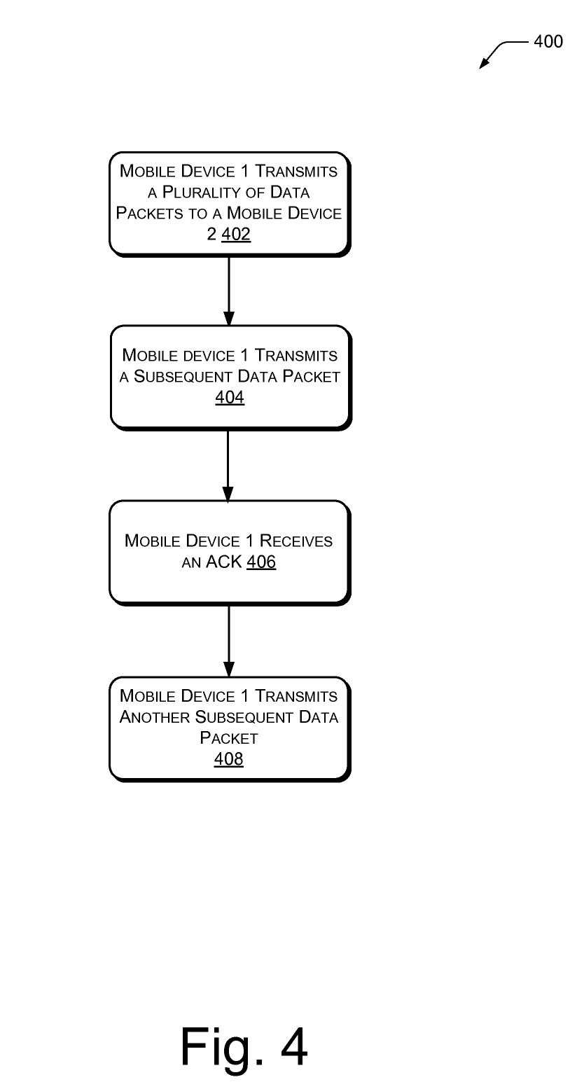

FIG. 4 is a flow diagram illustrating an example process 400 for dynamic assignment of a data rate according to another implementation. The process 400 may reference elements illustrated in FIGS. 1-2. However, generally, the disclosed process 400 may be implemented by a device, a system of devices, computer-readable medium including computer-executable instructions that, when executed, perform the process 400, and the like. The process 400 may be executed by a mobile device.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At act 402, a mobile device 1 (e.g., the mobile device 100) transmits a plurality of data packets to a mobile device 2 (e.g., a mobile device associated with the network infrastructure 122). Each of the plurality of data packets transmitted to the mobile device 2 required at least one retransmission of the data packet. The data packets were transmitted at a data rate chosen from a plurality of predetermined data rates. The plurality of predetermined data rates may include data rates 1, 2, 5.5, 6, 9, 11, 12, 18, 24, 36, 48 and 54 Mbit/s, where the data rates may be associated with one or more IEEE 802.11 standards. In a particular implementation, each of the plurality of data packets was transmitted at a first data rate. Subsequently, a successful retransmission of each of the plurality of data packets was transmitted at a second data rate, where the second data rate was less than the first data rate. In one example, the plurality of data packets is two data packets.

At act 404, the mobile device 1 transmits a data packet subsequent to transmitting the plurality of data packets transmitted in act 402. The mobile device 1 transmits the subsequent data packet to the mobile device 2 at a data rate that is at least two data rates lower than the data rate used in act 402. For example, if the mobile device 1, in act 402, used the data rate 54 Mbit/s to transmit the plurality of data packets before successful retransmission, then the data rate used in act 404 would be 36 Mbit/s to transmit the subsequent data packet.

At act 406, the mobile device 1 receives an ACK from the mobile device 2 indicating that the subsequent data packet of act 404 was received. At act 408, the mobile device 1 transmits another subsequent data packet at a data rate that is greater than the data rate used in act 404. For example, in act 408, the mobile device 1 transmits the another subsequent data packet at a data rate of 48 Mbit/s.

In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein may be implemented with hardware, software, firmware, or any combination thereof. In the context of software/firmware, instructions stored on one or more processor-readable storage media that, when executed by one or more processors, may perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed:

1. A system for accessing information, comprising:
a processor; and
a storage including instructions that, when executed by the processor, cause the processor to:
determine unsuccessful transmission of a data packet at a first data rate; and
retransmit the data packet at a second data rate, the second data rate at least two data rates lower than the first data rate.

2. The system according to claim 1, wherein the system is a mobile device having IEEE 802.11 wireless communication capability.

3. The system according to claim 1, wherein the first and second data rates are included in a plurality of data rates.

4. The system according to claim 1, wherein the instructions further cause the processor to receive an acknowledgment indicating that the data packet retransmitted at the second data rate was received, and transmit a subsequent data packet at a third data rate, the third data rate being greater than the second data rate.

5. The system according to claim 1, wherein the instructions further cause the processor to determine a plurality of unsuccessful transmissions of the data packet at the first data rate, the retransmit act executed after the plurality of unsuccessful transmissions of the data packet at the first data rate.

6. The system according to claim 1, wherein the instructions further cause the processor to retransmit the data packet a predetermined maximum number of times, wherein a final retransmit of the data packet is at a lowest data rate of a plurality of data rates.

7. The system according to claim 6, wherein the predetermined maximum number of times is seven and the lowest data rate the plurality of data rates is 1 Mbit/s.

8. A system, comprising:
a processor; and
a storage including instructions that, when executed by the processor, cause the processor to:
determine that at least a plurality of data packets required retransmission attempts in advance of determining successful transmission of the plurality of data packets;
decrement at least two data rate positions in a plurality of data rates to establish a decremented data rate; and
transmit a data packet at the decremented data rate.

9. The system according to claim 8, wherein the system is a mobile device having IEEE 802.11 wireless communication capability.

10. The system according to claim 8, wherein the instructions further cause the processor to receive an acknowledgment indicating that the data packet retransmitted at the decremented data rate was received, and transmit a subsequent data packet at an incremented data rate greater than the decremented data rate.

11. The system according to claim 10, wherein the incremented data rate is one data rate greater than the decremented data rate.

12. The system according to claim 8, wherein the plurality of data rates includes data rates 1, 2, 5.5, 6, 9, 11, 12, 18, 24, 36, 48 and 54 Mbit/s.

13. A tangible computer-readable medium storing computer-executable instructions that, when executed a processor, perform a method, comprising:
determining unsuccessful transmission of a data packet at a first data rate; and
retransmitting the data packet at a second data rate, the second data rate at least two data rates lower than the first data rate.

14. The tangible computer-readable medium including computer-executable instructions according to claim 13, wherein the first and second data rates are included in a predetermined set of data rates.

15. The tangible computer-readable medium including computer-executable instructions according to claim 14, wherein the predetermined set of data rates includes data rates 1, 2, 5.5, 6, 9, 11, 12, 18, 24, 36, 48 and 54 Mbit/s.

16. The tangible computer-readable medium including computer-executable instructions according to claim 13, wherein the determining act determines unsuccessful transmission of the data packet at the first data rate at least two times before executing the retransmitting act.

17. The tangible computer-readable medium including computer-executable instructions according to claim 13, further comprising determining successful transmission of the data packet at the second data rate; and transmitting a subsequent data packet at a third data rate, the third data rate being greater than the second data rate.

18. A tangible computer-readable medium storing computer-executable instructions that, when executed a processor, perform a method, comprising:
determining that first and second data packets were transmitted successfully at a first data rate after one or more retransmissions of each of the first and second data packets; and
transmitting a third data packet at a second data rate, the second data rate at least one data rate increment greater than the first data rate.

19. The tangible computer-readable medium including computer-executable instructions according to claim 18, wherein the first and second data rates are selected from a predetermined set of data rates.

20. The tangible computer-readable medium including computer-executable instructions according to claim 18, further comprising determining an unsuccessful transmission of the third data packet at the second data rate, and retransmitting the third data packet at a third data rate at least two decremented data rate positions lower than the second data rate, wherein the first second and third data rates are selected from a predetermined list of data rates.
